(19) United States
(12) Patent Application Publication
(10) Pub. No.: US 2011/0068700 A1
(43) Pub. Date: Mar. 24, 2011

(54) Method and apparatus for driving multiple LED devices

(75) Inventor: Jianping Fan, Orange, CA (US)

(73) Assignee: Suntec Enterprises

(21) Appl. No.: 12/586,308

(22) Filed: Sep. 21, 2009

(51) Int. Cl. H05B 37/02

(52) U.S. Cl. 315/185 R

(57) ABSTRACT

A series of methods of driving multiple LED devices with high efficiency balancing technique is disclosed. The regulation of the LED current is accomplished by switching operation to compensate the difference of the LED operating voltage. Reactive components are also employed to construct non-dissipative balancing networks to drive multiple LED strings with low losses. Additionally, a series of concept is presented to drive the LED devices from PFC voltage directly with low cost circuit architecture.

### BACKGROUND OF THE INVENTION

1. Field of the Invention

This invention generally relates to methods and apparatus of driving LED devices, and more particularly, to some unique concepts to drive multiple LED devices with low cost circuits while providing high efficiency power conversion and current balancing control.

2. Description of the Related Art

Light Emitting Diode (referred as LED hereinafter) is bringing revolutionary changes to the lighting industry and the world economy. High efficiency, compact size, long lifetime and minimal pollution etc. are some of the main advantages that provide people elegant lighting solutions and in the meanwhile perfectly fit into the green power initiative. Because LED is made with solid substances, it is also called Solid State Lighting (referred as SSL hereinafter) device. The inherent mechanical robustness of SSL device together with the features described above also enable itself to provide more reliable solutions that other lighting devices cannot do, and create many new applications in our daily life. Among them general lighting and display backlighting are the fastest growing areas with enormous economic potentials.

Despite the various advantages of the LED device, the relatively high cost of the device and the drive circuitry and low power handling capability also draw major concerns in its applications and design considerations. Because of the high cost of high power LED, e.g. devices around 1 W or so, and thermal management challenges related to the concentrated heat dissipation, most applications today use a high number of low power LED's normally from a few tens to a few hundreds to achieve the particular light intensity required for the application. With such high number of devices, circuit configuration is inevitably one of the top level design considerations that largely defines the architecture and total cost of the lighting system.

As is well known that the current-voltage characteristics of LED device is similar to a normal diode except the higher forward conduction voltage in a typical range of 2.2V to 3.3V. When the LED is forward biased, its forward current increases considerably with a small increase of the forward voltage, resulting in a steep current-voltage curve in the conduction region. This nature obviously gives rise to a challenge of LED current control when connecting multiple devices in parallel. In practice a group of LED's are normally connected in series to form an LED string in order to reduce the number of parallel branches and the complexity of the drive circuitry. But in large systems such as LCD backlight applications multiple LED strings still have to be used because of the limit of string voltage from safety and other design concerns and system reliability considerations. In such cases the brightness matching or current balancing of the LED strings becomes a major challenge in the system design. Mismatched LED current will result in uneven brightness distribution and deterioration of the system life.

FIG. 1 shows a typical conventional approach of driving multiple LED strings. For simplicity of the description, the figure shows only the symbolic circuit architecture. As shown in FIG. 1, the LED array 210 consists of multiple LED strings LED1 through LEDK. These LED strings are essentially connected in parallel to a common drive supply 100 on their anode side, and with a regulation device 132, represented as a MOSFET herein, and current sense resistor 142 connected in series with each string from the cathode side to power return ground GND. The current of the LED string is sensed from the sense resistor 142 and fed back to the inverting input of the corresponding error amplifier 82 and compared with the LED current reference signal IREF. The output of the error amplifier 82 then controls the gate of regulation device 132 to maintain the LED current at the value set by the reference signal IREF. In addition, a control switch 72, also represented as a MOSFET herein, is connected from the output of each error amplifier to ground. The gate of switch 72 is controlled by a periodic pulse train signal DPWM. When the DPWM signal is at high state the control switch 72 is turned on and thus switching off the regulation device 132 to cut off the LED current, and when DPWM is at low state the regulation device 132 resumes normal operation to regulate the LED current at the set value. Therefore by changing the time of low state of the DPWM signal the working duty of the LED current can be controlled accordingly to adjust the average brightness of the system. This type of brightness control is called digital dimming in the lighting industry in contrast to the term of analog dimming, which controls the amplitude of the LED current to adjust the brightness. Because the light conversion efficiency of the LED device varies with its forward current, digital dimming becomes the most popular approach in brightness control where the LED current can be set a sweet spot value to yield the best conversion efficiency.

In the above described system the LED current is essentially regulated by adjusting the voltage drop on the regulating device 132 to compensate the difference of the forward conduction voltage of the LED strings. The regulating device 132 works in a linear mode to dissipate the power resulted from the LED current and the difference between the drive supply voltage VDC+ and LED string voltage. In order to minimize such power dissipation the drive supply voltage VDC+ is always controlled at a minimum level that is just sufficient to maintain the current of the LED string with the highest forward voltage at the set value. This is accomplished by feeding the drain voltage of each regulation device 132 to the control circuit of drive supply 100. The lowest drain voltage signal will dominate the control to maintain the drive supply voltage VDC+.

Even though with the above approach, the regulating device still has to dissipate the power resulted from the difference of forward conduction voltage (it will be referred to as operating voltage hereinafter) of the LED strings. In fact the variation of LED operating voltage is quite large. Even with sorting in the manufacturing process the variation of the LED string operation voltage in each group still lies in the range of about 5% to 10% of its nominal operating voltage, which means that the maximum power dissipation on the regulating MOSFET could be about 10% of the power consumption of the LED string. Such dissipation not only reduces the efficiency of the system, but also generates excessive heat that further creates thermal problems, resulting in higher design complexity, higher system cost and lower reliability. If a short fault occurred with an LED element in a string, the corresponding regulating device has to drop additional voltage of the shorted LED and dissipate more power, which in turn will often result in over temperature of the device. Further from FIG. 1, in the conventional system the drive supply power for the LED strings is first converted from the 400V output of the Power Factor Correction (referred as PFC hereinafter) stage 10 to a standard low DC voltage, normally 24V as indicated in the figure, and then processed by another power conversion stage 100 to get the desired drive voltage to supply the LED strings. Such approach involves excessive multiple power conversion stages that on one hand lowers the system efficiency and on the other hand holds the system cost high, both resulting in critical disadvantages to the further success of the LED solutions. Therefore it is the intention of this invention to introduce a set of innovative LED drive concept, particularly for multiple LED string applications, to yield higher operating efficiency and lower system cost to offer more competitive solutions to the market.

### SUMMARY OF. THE INVENTION

This invention discloses a set of concept to drive multiple LED devices with unique current balancing technique, high efficiency circuit operation and simplified power conversion process. The proposed concept eliminates the conventional dissipative current balancing approach and instead, uses a set of non-dissipative balancing concept to drive multiple LED strings with matched brightness and current control. Considerations are also taken in this invention to drive the LED devices with minimized power conversion process, reliable device fault handling, and elimination of high voltage sensing circuitry etc. to provide practical high efficiency, low cost drive solutions for LED lighting and backlight applications.

In one embodiment the operation of the LED strings are controlled by electronic device in a switching manner to eliminate the linear dissipation of the regulating devices. The difference of the LED current is compensated by the PWM duty of the switching operation to yield matched average brightness from each LED string. High voltage sensing from the drain of the regulating MOSFET is also eliminated to lower the cost of the control circuitry.

In one embodiment a fixed level DC voltage slightly higher than the highest LED string operating voltage is supplied to the LED strings. A regulation device is equipped for each LED string to operate in a switching manner to control the LED current with the assistance of a serial inductor. Because of the small difference between the supply voltage and the string operating voltage, only a small inductance is need for the operation and the inductance can be realized by a Printed Circuit Board (referred as PCB hereinafter) embedded inductor to minimize the cost. Further, the supply power of the LED strings is converted by a single stage DC to DC converter from the high voltage output of the PFC stage directly. The DC to DC converter operates at fixed near full duty cycle to achieve soft switching operation with low cost half bridge or push-pull circuit and allow to use small filter capacitance and PCB embedded inductance.

In one embodiment a transformer balancing network is introduced to provide a lossless current balancing for the LED strings and allow a single control device operation. Because of the DC operation nature of the LED device, particular considerations are made in the circuit operation of various conversion topologies to provide periodic zero current instants to reset the transformer core flux and avoid the DC error accumulation. Apart from the lossless balancing function, the balancing network also provides easy fault detection and robust fault tolerant operations.

In one embodiment the LED string is connected with a bridge rectifier to form a circuit unit that can work directly with bi-directional drive voltage. The balancing transformer network can connect with multiple branches of such circuit unit to realize balanced drive without the constraint on circuit operation of providing periodic zero current instants for transformer flux resetting during the switching operation. Such balancing drive circuit can be powered ideally by a low cost single stage conversion circuit from the PFC output or other DC power sources.

In one embodiment the bi-directional LED circuit unit is connected in series with a capacitor, and the current balancing of multiple branches of such bi-direction LED circuit is realized by the matching of the capacitance value of the serial capacitors. Such capacitor balanced LED network can also be driven by a low cost conversion circuit without the constraint of providing periodic zero current instants for transformer flux resetting during the circuit switching operation.

In another embodiment each LED string is connected in series with an inductor, and the current balancing of multiple branches of such LED circuit is realized by the matching of the inductance value of the serial inductors. Such inductor balanced LED network can be driven by an isolated or non-isolated conversion circuit with design considerations of providing periodic zero current instants for transformer flux resetting to prevent the accumulation of DC bias current.

### BRIEF DESCRIPTION OF THE DRAWINGS

FIG. 1 shows a conventional LED drive system approach that consists of a PFC stage, a DC to DC voltage conversion stage, and LED drive control stage with dissipative linear LED current regulation.

FIG. 2 shows a typical circuit example of the concept to drive the LED strings with PWM compensated switching control to realize non-dissipative LED brightness regulation.

FIG. 3 shows two typical circuit examples to drive the LED strings with non-dissipative switching regulation with a fixed supply voltage, one with non-isolated power conversion and the other with isolated power conversion.

FIG. 4 describes the concept of transformer balancing network for multiple LED string current balancing.

FIG. 5 shows a set of typical waveforms of the transformer balancing network operation.

FIG. 6 shows application examples of the transformer balancing network with boost and fly back type power conversion circuit.

FIG. 7 describes application examples of the transformer balancing network with Buck and forward type power conversion circuit.

FIG. 8 shows the concept of implementing transformer balancing network with multiple bi-directional LED strings.

FIG. 9 shows the concept of using capacitor balancing network to balance the current of multiple bi-directional LED strings.

FIG. 10 describes the concept of using matched inductance to balance the current of multiple LED strings with bi-directional LED structure, and Buck and forward type power conversion topologies.

### DETAILED DESCRIPTION OF THE INVENTION

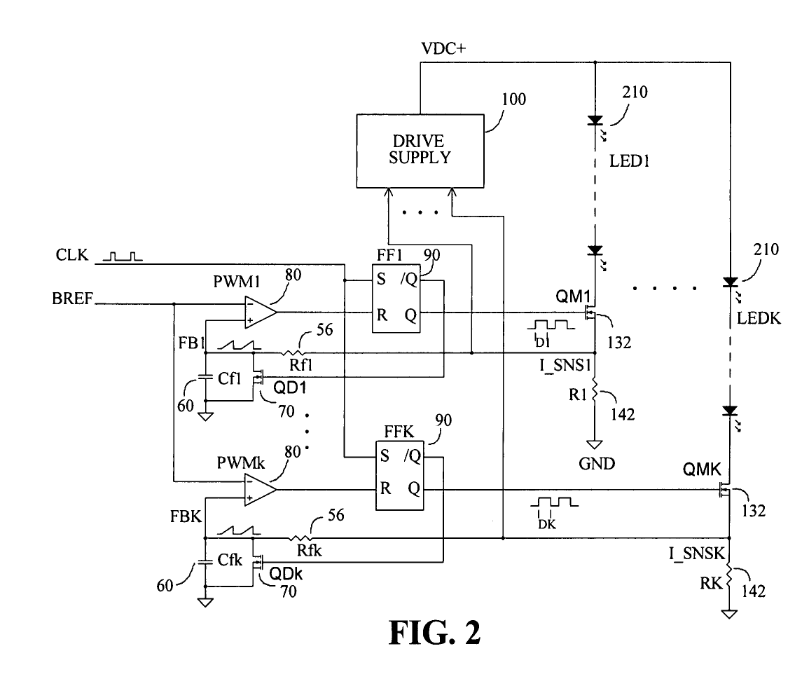

As described above that the purpose of this invention is to find an optimum approach to drive multiple LED strings with high efficiency operation and low system cost. Therefore the concept disclosed herein does not use any type of dissipative method to drive the LED's. FIG. 2 describes an example of such concept. As shown in FIG. 2, each LED string 210 is connected in series with a regulating device 132, represented as a MOSFET device herein for the convenience of description, and a sense resistor 142 with the drain terminal of the regulating MOSFET 132 connected to the cathode of the LED string 210 and the sense resistor 142 connected between the source terminal of 132 and the ground terminal GND. The anodes of all the LED strings 210 are connected together, essentially in parallel, to the power out VDC+ of a common drive power source 100. The current sense signal form the sense resistor 142 is fed to an integration circuit comprised by a resistor 56 and a capacitor 60 with the capacitor at ground side. The result of the integration is represented as the voltage across the integration capacitor 60 and fed to the non-inverting input of a PWM modulation comparator 80, where it is compared with a brightness reference signal BREF to determine pulse width of the PWM operation. The output of the PWM comparator 80 is fed to the reset input of a flip-flop 90, while the set input of the flip-flop is fed by a clock pulse train. The non-inverting output from terminal Q of the flip-flop is fed to the control gate of regulating device 132, and the inverting output from terminal/Q of the flip-flop is fed to a discharge switch 70, also represented as a MOSFET device herein for the convenience of description. The discharge switch 70 is connected across the integration capacitor 60 with its drain to the integration output node and source to the ground GND. As a rule of convention, all the signals described herein are referenced to the ground rail GND. It is worth to mention that the components described herein are all symbolic representations of the intended functions, and by all means that other types of components can also be used to fulfill the intended functions without departing from the spirit of this invention.

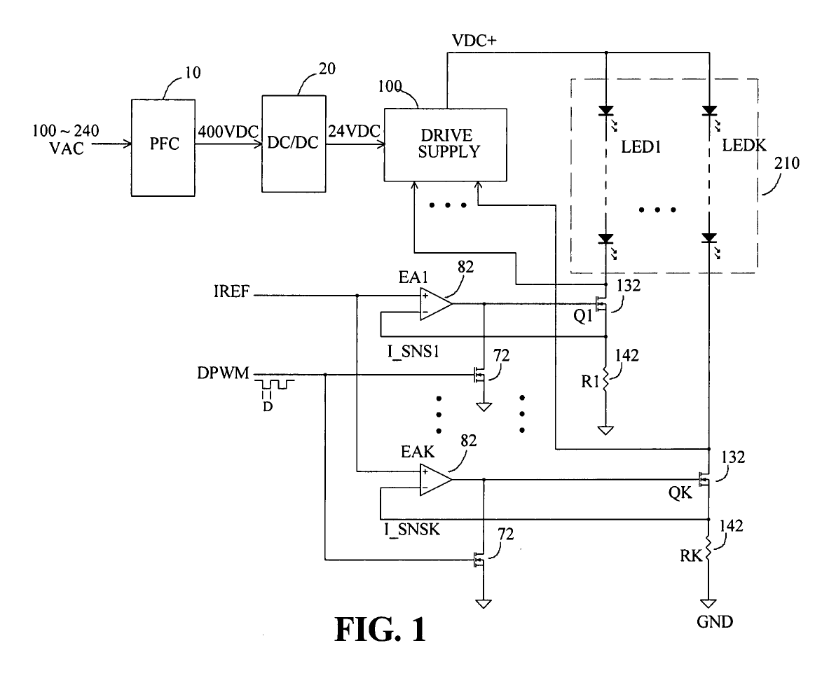

The essential difference of the circuit concept in FIG. 2 is that the regulating device 132 is working in switching mode, instead of linear mode as does in the conventional method of FIG. 1. By doing so the voltage drop across the regulating device is maintained at minimum level, i.e. the product of the LED current and the on resistance RDSon of the device, when 132 is on, and obviously yielding the minimum regulating losses. However, as is well known by the skilled in the art that differences of the operating voltage of the LED strings always exist and consequently when the regulating device is fully on, such difference would result in different current of the LED strings. Such difference of the LED current is compensated by the PWM pulse width of the regulation operation in this invention. As also well known by the skilled in the art that the instantaneous light output of a LED device is linearly proportional to its forward current over a wide range and the average brightness of the device over a certain time period is the integration of the instantaneous light output over that time period. Therefore if the LED current is switched on and off periodically and the on time the LED current can be controlled accordingly to its current signal such that the integration of the LED current over the on time interval can be kept constant, and the frequency of such operation is much higher than the response speed of human eyes, a constant brightness can be produced to human eyes regardless the instantaneous current level of the LED devices. The circuit operation of FIG. 2 is essentially based on this theory. The feedback signal to the non-inverting input of the PWM comparator 80 represents the time integration of the LED string current, and with the same reference signal at the inverting input of comparator 80, the integration of all the LED string current is maintained equal by the PWM modulation. When the instantaneous current of a particular LED string is higher, the integration signal to its corresponding PWM comparator rises faster when the regulation device is on and whenever it reaches the reference level BREF, the comparator changes its output state from low to high to reset the corresponding flip-flop 90. The non-inverting output of the flip-flop then turns off the corresponding regulating device to cut off the LED current. In the meanwhile, the inverting output of the flip-flop turns on the corresponding discharge switch 70 to reset the voltage on the integration capacitor 60 to zero, prepare for the operation of next cycle. A new cycle begins with the rising edge of the next clock pulse CLK, by then the flip-flop is set by the rising edge of the CLK signal, and its non-inverting output from Q terminal turns on the regulating device 132 and the inverting output turns off the discharge switch 70.

In this approach the LED drive voltage VDC+ is controlled at an optimum level by the feedback signal from the current sense resistor 142. The control rule is to set VDC+ at a minimum level that is just sufficient to maintain the current of the LED string of highest operating voltage at the predetermined value. This value is set in the control circuitry of the drive supply 100 as control reference, and the control circuit selects the lowest feedback signal from the current sense of the LED strings to dominate the control of the drive supply output VDC+. This approach is also advantageous over the conventional method described in FIG. 1. Because the current sense signal of all the LED strings in FIG. 1 are essentially equal, and therefore the signals from the drain of the regulating device have to be used to control the supply voltage VDC+. Such approach requires higher voltage withstanding capability of the control input circuitry, because in practical applications it has to ensure the safe operation of the circuitry under fault conditions such as a particular LED string is shorted, under which the feedback voltage from the drain of the regulating device 132 rises to the level of VDC+. With the approach of FIG. 2, the feedback signal is from the source of regulating device, a current limit or protection circuit can be easily implemented to turn off the device when the sense signal from the sense resistor 142 reaches a predetermined value and prevent the current sense signal from rising to a dangerous level. Under such circumstances, the voltage rating of the drive supply control circuitry can be much lower, which will translate to lower components cost and higher reliability.

As mentioned before, the circuit described in FIG. 2 only serves the purpose of symbolic representation of the intended functions. In practical applications other types of components or circuitry can also be utilized to fulfill the described functionalities without departing from the spirit of this invention. For instance, the integration function represented by resistor 56 and capacitor 60 can be also be fulfilled by replacing resistor 56 with a controllable current source with its current amplitude proportional to the signal level from the sense resistor 142. Apart from analog implementation, such integration function can also be realized by digital means without departing from the functionalities intended herein. Further, when the LED current is a constant DC over the integration period, the result of the described integration is in fact the multiplication product of the sensed LED current signal and the time period, and hence a signal multiplier could be used to accomplish the intended integration function. With the technologies available today the function blocks described in FIG. 2 can be implemented in an integrated circuit with very low cost to realize such high efficiency LED drive system.

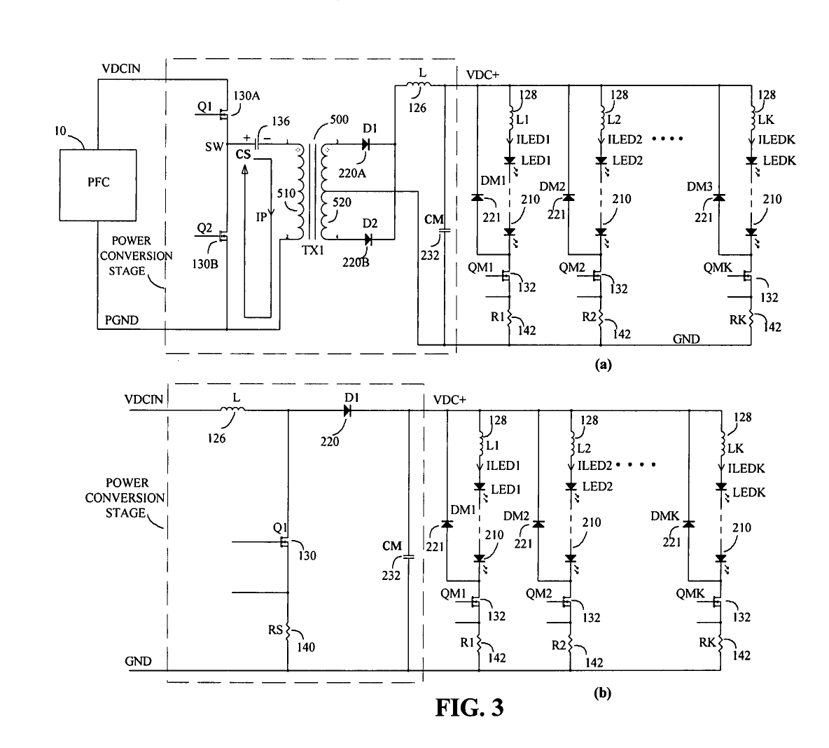

FIG. 3 describes another high efficiency LED drive concept. FIG. 3(a) shows an example with isolated drive supply, and FIG. 3(b) shows a non-isolated drive supply system. As described earlier, in the conventional system the LED drive power is obtained by two-stage power conversion from the PFC output. In contrast the circuit concept in FIG. 3(a) utilizes a single stage half bridge circuit to convert the LED drive power from the PFC output directly. Such approach obviously reduces the cost and efficiency loss associated with the eliminated power conversion stage. In addition, efficiency can be further improved by operating the half bridge circuit at near full PWM duty, under which circumstance zero voltage soft switching can be obtained with the low cost half bridge circuit to reduce the switching loss significantly. The reason can be explained with the circuit operation in FIG. 3(a). In FIG. 3(a), the circulation loop of the current IP of the primary winding 510 of transformer 500 shows the situation after the high side switching MOSFET 130A is turned off. Under steady state operation a voltage of (VDCIN)/2 is established across capacitor 136 with the polarity of positive left and negative right, as shown in FIG. 3(a). When 130A is on the transformer primary winding 510 is impressed with a voltage of (VDCIN)/2 and the current in the primary winding is established in the path from VDCIN through power switch MOSFET 130A, capacitor 136, primary winding 510 to PFC power ground return PGND. When 130A is turned off, the current in the primary winding changes its path to freewheel in the circulation loop through capacitor 136, primary winding 510, and the body diode of the low side switching MOSFET 130B to keep its continuity, forcing the drain to source voltage of MOSFET 130B to be near zero. If the MOSFET 130B is turned on under such circumstance, i.e. while its drain to source voltage is near zero, a zero voltage soft switching is obtained. On the other hand, however, because of the existence of the voltage across capacitor 136, the freewheel current decays very fast and its continuity can only be maintained for a relatively short time. Therefore the half bridge circuit has to operate at near full duty, so that low side MOSFET 130B turns on shortly after the high side MOSFET 130A is turned off while the drain to source voltage of 130B is still clamped near zero by the freewheeling current. By a rule of thumb, the range of such near full duty can be estimated as around 42% to 48%, referring to 50% as full duty. Note that such number is not absolute and it depends on the circuit parameters such as the primary winding leakage inductance of the transformer 500 etc. that related to the sustaining time of the freewheel current. On the other hand, if the circuit operates at smaller PWM duty, the freewheel current would decay to zero and the drain to source voltage of the low side MOSFET 130B starts rise and eventually settle at the level of half VDC+ before it is turned on, and the opportunity of soft switching is lost. In symmetry such situation is also true at the other switching transition in duality when the low side MOSFET 130B is turned off followed by the turn-on of the high side MOSFET 130A. Further, when the circuit is operating at near full switching duty, the filter inductor 126 and filter capacitor 232 can use very small values that will offer another level of cost saving for the system.

While the power conversion circuit operates at the above described near full PWM duty condition to obtain the maximum efficiency, the soft switching duty range may not be wide enough to cope with variations of the PFC voltage VDCIN and the operating voltage of the LED strings. In order to maintain sufficient range for the LED current regulation, the circuit herein described in FIGS. 3 (a) and (b) utilizes a small inductor 128 to help to extend the headroom of the drive supply VDC+ over the LED string voltage. On the other hand, however, because the necessary inductance value is normally proportional to the voltage across it at a given switching frequency, in order to keep the inductance value of 128 relatively small, the headroom of VDC+ should not be too large. So the optimum value should be just sufficient to provide enough margin for the LED string current regulation. When taking into account of all the related variation factors, 20% of the average LED string operating voltage would be a reasonable guideline for a typical application. Again such number could vary with particular parameters of a practical system. With such relatively small working voltage across the inductor and a properly selected switching frequency, the inductance needed for 128 can be small enough to be realized with a coil made by the circular traces on a Printed Circuit Board (referred as PCB hereinafter). Such realization is almost free of cost. Further, if the inductance needs to be higher, a magnetic core can be embedded into the PCB coil to increase the inductance. Furthermore, because the inductance of 126 also does not need to be large because of the near full duty operation, it can be realized by such embedded PCB inductor structure as well.

The LED current regulation of the circuit in FIGS. 3(a) and (b) is performed by the PWM switching operation of the regulating device 132. The same control rule and control circuit concept of FIG. 2 also applies herein—the difference of the current amplitude is compensated by the PWM duty of the switching operation, the PWM modulation is accomplished by comparing the integration of the sensed LED current signal with the brightness reference to keep the average brightness of each LED string equally to the same set level. For conciseness of description, the control circuit section is not shown in FIG. 3. One particular point to be noted is that the switching frequency of the PWM operation of FIG. 2 and FIG. 3 concept is different. The PWM switching of the regulation device 132 in FIG. 2 concept is at the digital dimming frequency in a typical range of 100 Hz to 1 KHz, while the switching operation of 132 in FIG. 3 concept is at a power conversion operating frequency in a typical range of 100 KHz to a few MHz, and can be preferably synchronized with the switch frequency of the power conversion stage at the front end, i.e. the half bridge circuit in FIG. 3(a) and the boost circuit in FIG. 3(b). The digital dimming of the circuit concept in FIG. 3 will be performed by turning on and off the power conversion stage periodically at the digital dimming frequency in the range of about 100 Hz to 1 KHz. Thus in each digital dimming cycle each LED string performs a burst of equal number of PWM operation, and each PWM operation cycle produces equal light output in average, eventually equal brightness is obtained from each LED string during each digital dimming period. Finally, it should be noted that because of the existence of inductor 128, in each PWM operation cycle the current stored in inductor 128 will freewheel in the loop of inductor 128, LED string 210 and freewheel diode 221, and quickly decay to zero because of the significant voltage that to be produced in order to keep the LED string conducting before the current extinguishes. A capacitor can also be connected in parallel to each LED string to make the LED current smoother.

The drive concept described above in FIG. 2 and FIG. 3 uses a common brightness reference for all the LED strings. Since each LED string has a separate brightness control circuit, different brightness reference for each individual LED string can also be applied to get different brightness distribution from the LED strings accordingly. Such feature will allow the implementation of more sophisticated dimming control such as local zone dimming in display applications where the brightness of the LED string can be controlled dynamically according the picture content of the area that is being lighted by the particular LED string. On the other hand, in most lower cost applications the brightness of the LED strings normally only need to be controlled uniformly and if a LED current balancing technique can be established without the involvement of controlled semiconductor regulator for each LED string, the whole LED backlight system can use only one controlled regulating device to control the total LED current. Further, it is also preferred that the power losses can be minimized in the balancing operation of the LED current. Such goal can be realized with the reactive balancing method described in the following.

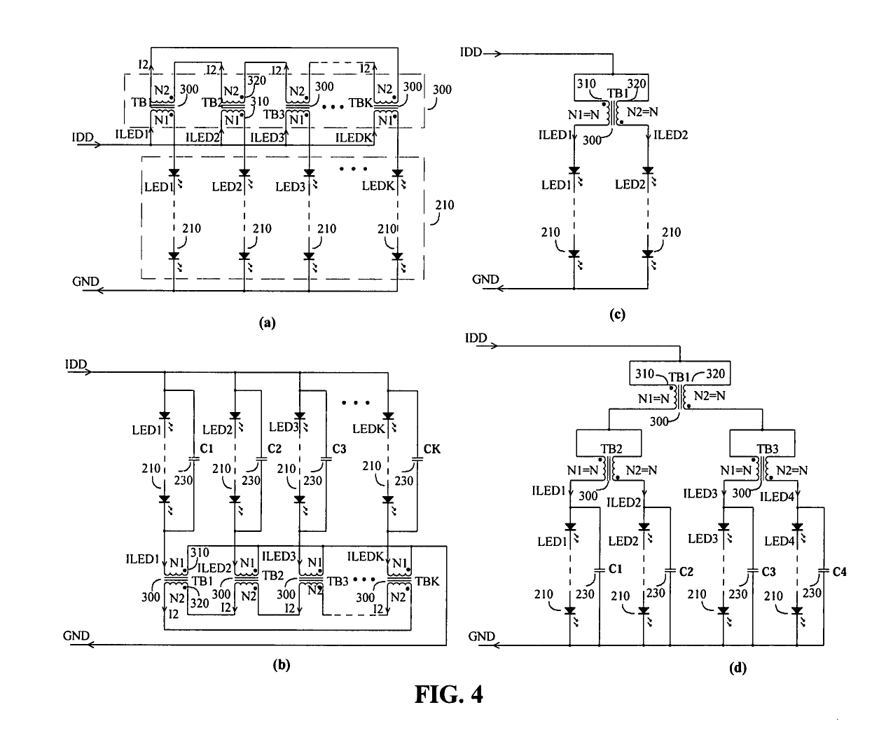

A non-dissipative current balancing method for multiple LED strings by using a transformer network is depicted in FIG. 4. As shown in FIG. 4(a), 300 is the balancing transformer element with a primary winding 310 and a secondary winding 320. A series of such balancing transformers are employed with each of their primary winding 310 connected in series with a LED string 210 to form a serial circuit branch, and all such serial branches are then connected in parallel to a common supply source with the LED anode side of the branch to the positive terminal of the supply source and the LED cathode side of the branch to the return terminal of the supply source. The secondary windings 320 of the balancing transformers are connected in series to form a single circuit loop. The connection polarity of the secondary windings follow the rule that during operation, when current flows through the primary winding of the balancing transformers, the induced current in the secondary windings flow in the same direction in the secondary loop. It should be noted that such physical connection of the balancing transformer loop was invented by Jin in the U.S. Pat. Nos. 7,242,147 and 7,294,971. However, Jin's invention is intended with AC supply source only and the load is essentially Cold Cathode Fluorescent Lamps (referred as CCFL hereinafter) which can only be driven by an AC power in nature. The invention disclosed herein uses the above described balancing network to equally distribute a supply current with DC component to multiple LED strings or other types of load that operate with DC current in nature. The theoretical principle of such balancing mechanism is described herein below.

As well known by the skilled in the art, in an ideal transformer the voltage of the primary and secondary windings are induced by the magnetic flux change in the transformer core as

V₁=N₁dΦ/dt (Equation 1)

V₂=N₂dΦ/dt (Equation 2)

Wherein V₁ and V₂ denote to the voltage in the primary and secondary winding respectively, N₁ and N₂ denote to the turns of primary and secondary winding respectively. Φ is the flux in the transformer core that couples to both the primary and secondary windings, and is generated by the currents from both the primary and secondary winding as

Φ=μAN₁I₁/l−μAN₂I₂/l=μA(N₁I₁−N₂I₂)/l (Equation 3)

Wherein μ is the magnetic permeability of the transformer core, A is the cross section area of the transformer core, and l is the effective length of the magnetic path of the transformer core. Combining equation 2 and 3 results in

V₂=(μAN₂/l)·d(N₁I₁−N₂I₂)/dt (Equation 4)

Since the secondary winding of the transformer is essentially shorted, by neglecting the voltage drop on the DC resistance of the winding, the voltage across the winding is zero, therefore it further results

(μAN₂/l)·d(N₁I₁−N₂I₂)/dt=0 (Equation 5)

d(N₁I₁−N₂I₂)/dt=0, dI₁/dt=(N₂/N₁)dI₂/dt (Equation 6)

From equations 6 it is clear that by connecting the secondary winding of the transformers in a short circuit loop, the change rate of the current of the primary winding is proportional to the change rate of the current of the secondary winding by a factor of the transformer turns ratio N₂/N₁. In the circuit described in FIG. 4(a), the current of the primary winding 310 of the balancing transformer is essentially the current I_{LED1}, I_{LED2}, . . . I_{LEDK} of the LED strings connected in series with the primary winding of the corresponding balancing transformers. And also since the secondary winding of all the balancing transformers are connected in a single short circuit loop, the current of all the secondary windings are equal and represented as I₂ in the Figure. Therefore if all the balancing transformers use the same turns ratio of N₂/N₁, the change rate of all the LED current can be set equal by such arrangement, i.e.

dI_{LED1}/dt=dI_{LED2}/dt= . . . =dI_{LEDK}/dt=(N₂/N₁)dI₂/dt=(1/K)·(dI_{DD}/dt) (Equation 7)

Wherein I_{DD} is total current supplied to the LED strings, and K is the total number of LED strings. Since the current change rates are equal all the time, if the initial values are also equal, the integration of these LED currents over the same time span will be exactly equal, i.e.

∫I_{LED1}/dt=∫I_{LED2}/dt= . . . =∫I_{LEDK}/dt=(1/K)∫I_{DD}/dt (Equation 8)

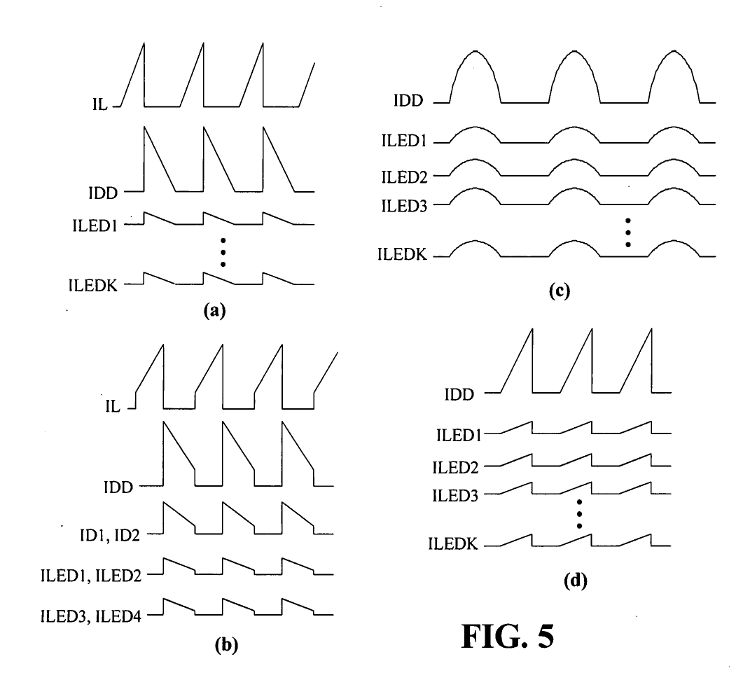

From equation 8 it can be concluded that when using the balancing transformer network to drive multiple LED strings as described in FIG. 4(a), the time varying current supplied from their common input can be evenly distributed to the LED strings by the balancing function of the transformer network if the initial value of the currents are all equal. From this point if the time varying supply current contains DC component, the current waveform has to carry periodic zero crossing intervals so that the integration function can be performed periodically over each period and the initial value is always reset to zero for the integration operation of next period. In fact, such approach also signifies the fundamental requirement of the circuit operation that at DC biased operating condition the magnetic flux of the transformer core has to be reset to zero periodically and such reset is ideally performed during the zero crossing interval of the current waveform. In actual implementation, when furnished with practical power conversion circuit, such requirement can be satisfied in most cases by properly arranging the switching action of the converter operation. Some typical time varying waveforms from practical power conversion operations are shown in FIG. 5, and will be explained in more details in the following text with the particular application examples.

Apart from connecting in series with the LED string at the anode side, the primary winding of the balancing transformer can also be connected in series with the LED string at the cathode side as shown in FIG. 4.(b). In fact, each of such serial branch has the freedom to use either type of the connection and eventually paralleled to the common supply source. The only rule to follow is to make sure that in the secondary winding loop the current induced in each secondary winding flows in the same direction in the loop. The balancing result will be the same as governed by equations 7 and 8. Further, if the current of the LED strings need to be controlled in certain type of proportional distribution, instead of all equal, it can be achieved by simply using different turns ratio for the transformers, and the LED current of each string will be set proportionally according to the turns ratio.

FIG. 4(c) shows another type of balancing transformer. Different from FIGS. 4(a) and (b), the balancing transformer in FIG. 4(c) uses the same number of turns for its primary and secondary windings. Each of the two windings 310 and 320 is connected in series with a LED string and the formed two serial branches are connected to a common supply source in parallel. The rule of the connection polarity is that the flux produced by the current flowing in winding 310 and 320 cancels each other and therefore when the current of the two LED strings are equal, the flux in the transformer is zero. Such physical connection of the balancing transformer was originally invented by Ushijima in his U.S. Pat. No. 7,589,478. However, Ushijima's invention works with only AC supply source and the load is essentially discharge lamps that can only be driven by an AC power in nature. The circuit in FIG. 4(c) uses the balancing transformer to equally distribute a supply current with DC component in nature to two LED strings or other types of DC current load without the restriction of having to be AC in nature. When time varying current flows through windings 310 and 320, if the currents in the two winding are not equal, e.g. if the current of winding 310 is greater than winding 320, an excessive flux will be produced in the transformer core which will in turn generate a correction voltage with the polarity of positive on upper side and negative on lower side in winding 310 to reduce the current of LED1, and another correction voltage of negative on upper side and positive on lower side in winding 320 to increase the current of LED2, and eventually forcing the current of the two LED strings back to equal. In applications with more LED strings, such balancing configuration can be cascaded to extend the number of branches. FIG. 4(d) shows an example of driving four LED strings. The configuration of further extension is obvious to the skilled in the art and therefore would not be further described herein. The balancing transformer can also be connected at the cathode side of LED strings without affecting any of the balancing result. For the convenience of description, the balancing transformer structure in FIGS. 4(a) and (b) will be called type 1 balancing network and the balancing structure in FIG. 4(c) and (d) will be called type 2 balancing network hereinafter. In practice type 1 balancing network and type 2 balancing network can also be combined in a balancing structure to form a mixed balancing network to yield the same balancing result under the same spirit described hereinabove.

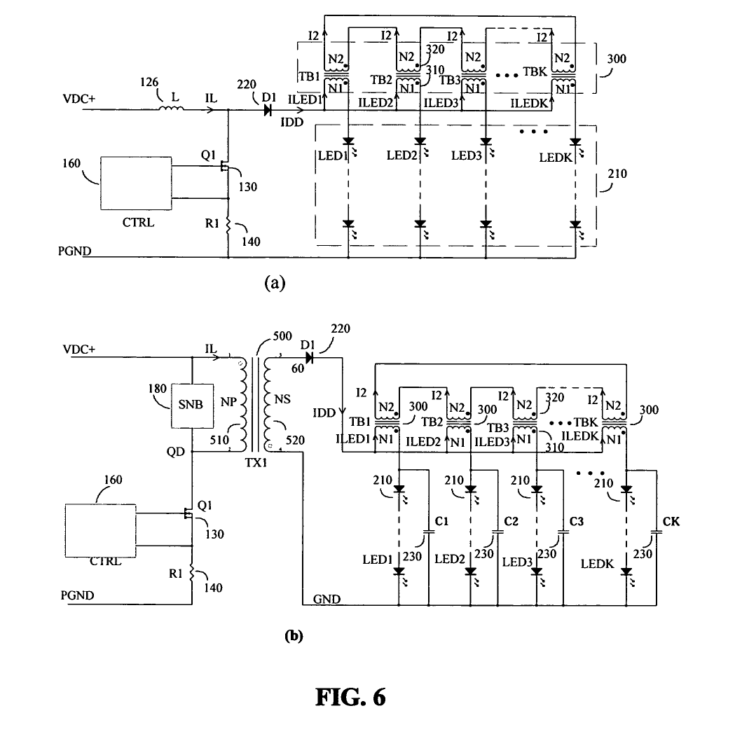

The above described balancing networks can be used in many types of practical LED driving systems. FIG. 6(a) shows an application example of using a boost type converter to drive multiple LED strings with type 1 balancing network. In FIG. 6(a) inductor 126, switching MOSFET 130, sense resistor 140 and rectifier diode 220 comprise the main power circuit of the boost converter. During operation when the switching MOSFET 130 is turned on, the current IL of inductor 126 builds up. When 130 is turned off the current stored in inductor 126 tends to keep its continuity by forcing the diode 220 forward biased and freewheel through the path of input voltage terminal VDC+, inductor 126, diode 220, the parallel load network comprised by the balancing transformer network 300 and the LED strings 210, and return to the input power ground PGND. During this course the balancing network automatically distribute the freewheel current IDD evenly among the LED strings connected to each of the transformer primary windings. When the switching MOSFET turns on again, the rectifier diode 220 is reverse blocked and IDD drops to zero. The inductor 126 starts another cycle of energy storage charge to build up its inductive current. During freewheel period the freewheel current IDD may extinguish before the switching MOSFET turns on. As well known to the skilled in the art, such operation condition is referred as discontinuous inductor current operation. Or alternatively, the freewheel current may not have decayed to zero when the switching MOSFET turns on at the following switching cycle, under which condition it is called continuous inductor current operation. A fact of such converter operation is that under both continuous and discontinuous current conditions the supply current to the balancing network and LED strings always drops to zero when the switching MOSFET turns on and reverse biases the rectifier diode 220, therefore the transformer core can always be reset and the balancing network works effectively under both conditions without any problem. The operating waveforms of discontinuous current operation are shown FIG. 5(a). Type 2 balancing network can also work effectively in such application under both continuous and discontinuous current conditions. The operating waveforms with the type 2 network of FIG. 4(d) under continuous current condition are shown in FIG. 5(b). In such approach since the LED current is equally distributed by the balancing network, only the total current need to be controlled in order to get the desired LED operating current. This can be realized with a closed loop control by feeding back the inductor current signal sensed from resistor 140 to the control circuit 160 and adjust the switching operation of switching device 130 accordingly to maintain the inductor current at the preset level. On the other hand, if the input voltage VDC+ is stale, it would also be possible to use a fixed inductance value of 126 and a fixed on duty of the switching operation to obtain the desired LED current in open loop manner. Additionally, a digital dimming operation can also be realized by turning on and off the switching operation of the boost conversion circuit periodically at a low frequency, typically in a range of 100 Hz to 1 KHz, and changing the on duty of the converter operation to adjust the brightness of the system. Finally, each LED string can also be paralleled by a capacitor 230 to make its current smoother, as shown in FIG. 6(b).

As addressed hereinbefore, in modern LCD backlight applications converting the LED drive power from the PFC output directly provides significant advantages in both efficiency improvement and cost savings. FIG. 6(b) shows a typical example of such concept with the balancing network solution. The main difference of the circuit in FIG. 6(b) is that the energy storage element is changed from an inductor to a fly back transformer 500 in order to provide safety isolation between the PFC side and the LED side. The operation of the circuit is similar to the circuit of FIG. 6(a) with a common feature that when the switching MOSFET 130 is turned on, inductive energy builds up with the increasing current in the primary winding 510 of transformer 500. During this period the rectifier diode 220 is reverse biased and no energy is transferred to the LED load. When 130 is turned off, the current stored in primary winding 510 tends to keep its continuity and starts developing fly back voltage in both the primary 510 and secondary winding 520. By the polarity arrangement of the fly back transformer 500, the voltage across its secondary winding voltage turns to the polarity of positive on upper side and negative on lower side, and eventually rises to the level to make the rectifier diode 220 forward biased, the stored energy in primary winding 510 then couples to the secondary winding and current starts flowing into the LED strings 210 under the even distribution of the balancing network 300. Same as the boost circuit in FIG. 6(a), when MOSFET 130 is on diode 220 is reverse biased and the supply current to the balancing network drops to zero. So the balancing network always has a time interval to reset and hence works effectively with both continuous and discontinuous current conditions. Again the level of the LED current can be controlled by feeding the primary current signal sensed from resistor 140 to the control circuit 160 and maintained by the regulation function of 160. Digital dimming can also be realized in the same manner as described hereinbefore in the last paragraph. If the PFC voltage is stable, LED current can also be obtained by open loop operation with fixed inductance value of 510 and fixed switching duty of 130. The parallel smoothing capacitor 230 can also be connected in parallel with the LED string as shown in FIG. 6(b). One particular point should be noted is that because of the existence of the leakage inductance, the energy stored in the leakage inductance during the on period of 130 cannot be coupled to the secondary side, and if such energy is not properly disposed, it could result in excessively high voltage overshoot at the drain of the switching MOSFET 130 and cause over voltage breaks down of the device. To prevent such situation a snubber circuit, indicated as 180 in FIG. 6(b), has to be employed to absorb the energy stored in the leakage inductance and suppress the overshoot voltage. Such snubber circuit can be a dissipative type with passive components, or a non-dissipative type with the involvement of some active devices to control the circulation of the energy among the reactive components of the circuit to contain the MOSFET drain voltage. Such technique is familiar to the skilled in the art and will not be discussed in details herein.

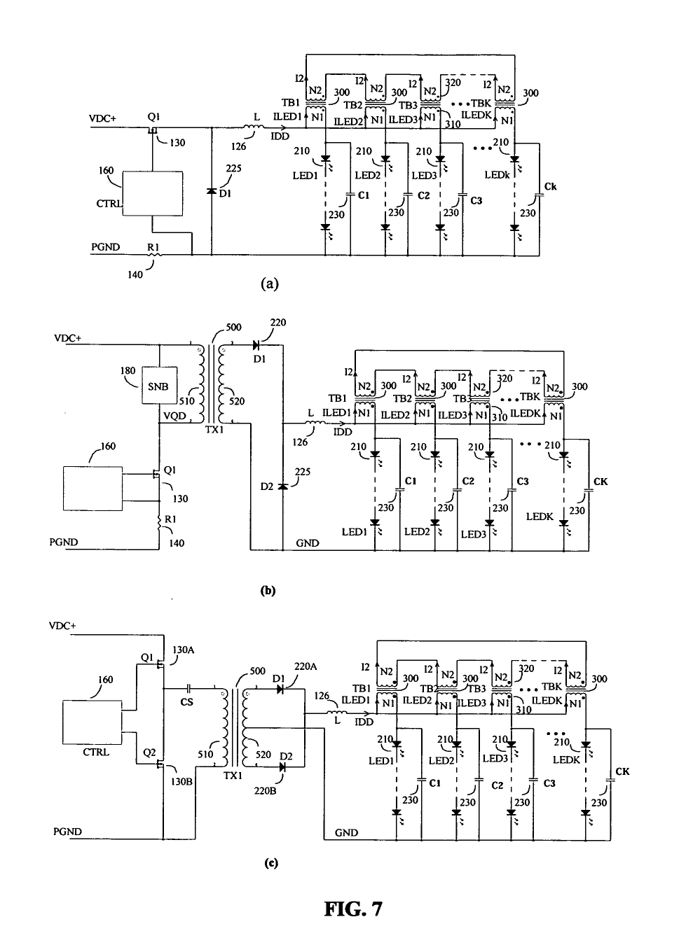

The transformer balancing network can also be implemented with forward type drive circuit. Some conceptual examples are depicted in FIG. 7. FIG. 7(a) shows an example of using type 1 balancing network with a Buck type drive circuit. When isolation between the input supply and the LED circuit is needed, or a particular voltage transfer ratio that is difficult for a Buck circuit is required, transformer isolated drive circuit can be utilized as also shown in FIG. 7. FIG. 7(b) shows a forward drive circuit and FIG. 7(c) shows a half bridge drive circuit. The common feature of this type of circuit is that when the switching device, referred herein as MOSFET 130 in FIGS. 7(a) and (b), and 130A and 130B in FIG. 7(c), is turned on, energy flows through inductor 126 to the LED load, and when the switching device is turned off, the energy flow from input is stopped but the remaining energy in the inductor 126 starts freewheel and transfer to the load until the stored inductive energy extinguishes. In such sense, other conversion circuit topology such as push-pull, full bridge, push-pull forward, double forward circuit etc. all exhibit the same feature of such energy transfer and hence are all applicable to the drive concept described herein. Taking an example of the circuit in FIG. 7(c), when the switching device 130A is turned on, rectifier diode 220A is forward biased and 220B is reverse blocked. Current IDD flows through 220A and inductor 126 to the LED strings 210 with even current distribution by the balancing function of the balancing network comprised by the balancing transformers 300. When 130A is turned off, the inductive current of inductor 126 tends to keep its continuity and freewheels through the path of inductor 126, balancing transformer primary windings 310, LED strings 210, the transformer secondary winding 520, and the rectifier diodes 220A and 220B. The current of inductor 126 could extinguish or remain at certain level before the next switching device 130B is turned on. When 130B is turned on, rectifier 220B is forward biased to supply current to the LED strings through the balancing network again. The process is symmetrical to the operation of 130A. The operation of the circuit in FIGS. 7(a) and (b) are similar with the exception that there is only switching device 130, and when it is on the rectifier diode 220 is forward biased to transfer energy to the load, and when 130 is off, the freewheel current passes through diode 225 only. Also the freewheel current from inductor 126 could extinguish or continue flowing before the switching device turns on again at next cycle. But different from boost or fly back type circuit, in such forward type conversion applications, sufficient off time has to be guaranteed for the switching device operation to allow the freewheel current of inductor 126 to extinguish before the turn on of next cycle, in order to reset the magnetic flux and prevent DC bias accumulation in the balancing transformer core. Such requirement can be met by choosing design parameters including the inductance value of 126, turns ratio of transformer 500 etc. according to the input voltage, LED operating voltage and the target LED current. Again while the LED current is maintained by the switching operation of the conversion circuit, digital dimming can be further realized by turning on and off the switching operation of the conversion circuit periodically at a low frequency with adjustable on duty to control the brightness.

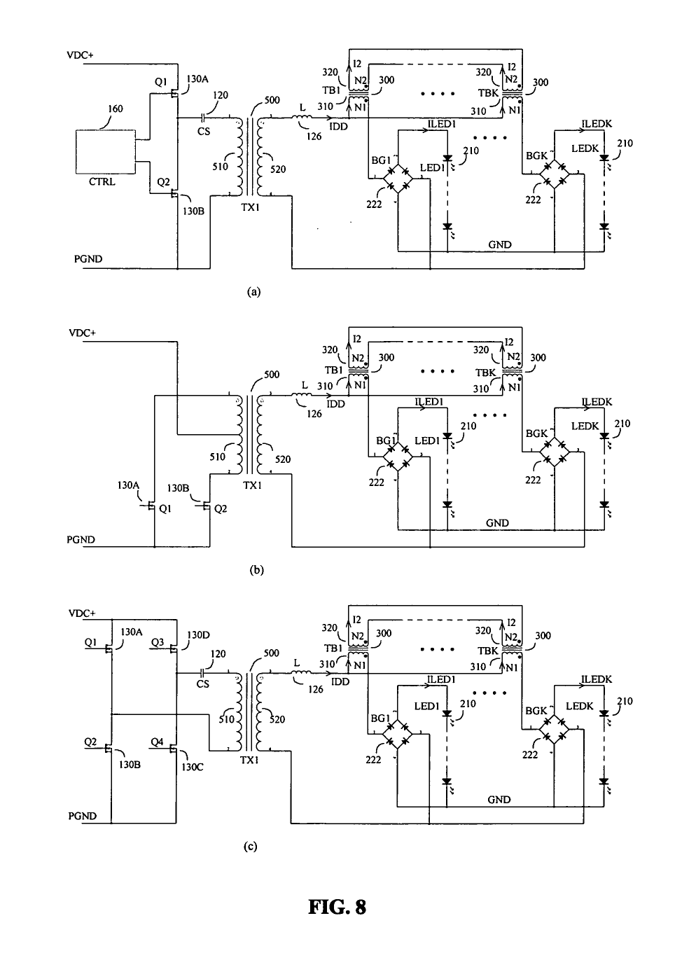

As described above, a disadvantage of the forward type drive circuit is that it has to provide sufficient off time during the switching operation to avoid DC bias accumulation in the balancing transformer. This essentially prevents the conversion circuit to operate at near full PWM duty condition to obtain the optimum efficiency. In order to obtain such operating merit, especially when converting the drive power from the PFC output directly, another concept is described herein with the conceptual circuits shown in FIG. 8. As can be seen from FIG. 8, three most popular symmetrical switching topologies are utilized as the conversion stage to obtain the LED drive power from the DC input VDC+. FIG. 8(a) shows a half bridge circuit with two switching devices 130A and 130B, FIG. 8(b) shows a push-pull circuit, and FIG. 8(c) shows a full bridge circuit with four switching elements 130A, 130B, 130C and 130D. In most practical applications the DC input is the output voltage from PFC stage. However, it will by no means limit the application of this concept with other DC input sources.

The key feature of the circuits in FIG. 8 is the configuration of the LED strings. As can be seen in FIG. 8, each LED string 210 is combined with a bridge rectifier 222 to form a bi-directional LED structure with the anode of the LED string connected to the positive output terminal of the bridge rectifier 222 and the cathode of the LED string to the negative output terminal of 222. The two AC inputs of the bridge rectifier serve as the input terminals of the bi-directional LED structure and are connected in series with the primary winding 310 of the balancing transformer 300 to receive power from the secondary winding 520 of transformer 500 through an inductance 126. With such configuration the balancing transformer network and the LED strings can receive the bi-directional output from the transformer secondary winding directly without rectification. Because by the intrinsic nature the transformer 500 cannot transmit any DC voltage component to the secondary side, the current flowing through the primary winding 310 of the balancing transformer is bi-directional with balanced positive and negative half cycle, the potential problem of DC bias does no exist. Therefore the balancing circuit can work with any duty cycle of the converter switching operation without limitation. Because of this advantage, the conversion stage can favorably work at near full duty operation and enjoy the benefit of soft switching and high efficiency operation with a low cost half bridge or push-pull circuit, as detailed hereinbefore in paragraph [0029]. In practical designs the power transformer turns ratio can be selected such that according to the value of the input voltage and LED operating voltage etc. the desired LED current can be obtained when the switching device 130A, 130B etc. are operating at near full duty. By such design the converter circuit can operate in open loop at a fixed duty near full cycle, or in closed loop to maintain a small range of LED current regulation with boundaries to limit the duty cycle within the range that soft switching operation can be maintained. The brightness control of the system can still be fulfilled by digital dimming method, with which the switching operation of the conversion circuit is turned on and off periodically at a low frequency with adjustable on duty to set the brightness level. Additionally, it would also be possible to incorporate a closed loop brightness control in the digital dimming operation, with which the variation of the LED current of the whole backlight system can be compensated by the on duty of the digital dimming operation. The implementation of such closed loop control at digital dimming level is similar to the concept described hereinabove in paragraph [0026], with the exception that the integration is performed with the current burst of multiple converter switching cycles during the converter on period of the digital dimming operation, and such integration result is compared to a reference signal representing the total brightness of the backlight system. Such approach can utilized to compensate the variations of the LED current of the whole product set and thus maintaining constant brightness for the whole product series during manufacturing. It is also worth to note that at near full duty operation only a small inductance of inductor 126 is needed to smooth the current. Therefore it is possible to utilize the leakage inductance of the transformer secondary winding 520 to replace inductor 126 to further reduce the system cost. Finally, it should be noted that although the power conversion stage can favorably work at near full duty operation to obtain soft switching condition with half bridge or push-pull circuit, the circuit can also work at wide duty range with full regulation control of the LED current. In such situation soft switching can still be obtained with the full bridge circuit in FIG. 8(c), but the half bridge (especially in symmetrical switching condition) and push-pull circuit will not be able to maintain soft switching operation at low duty cycle.

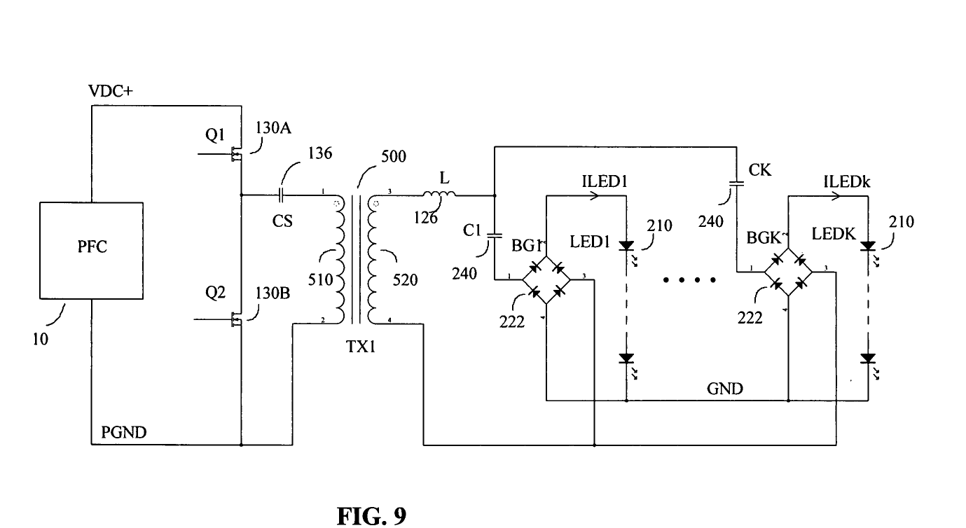

Because the bi-directional LED structure described hereinabove works with bi-directional drive voltage, other reactive components can also be employed to match the LED current. FIG. 9 shows an example of using capacitor for LED current balancing. As shown in FIG. 9, each bi-directional LED structure is connected in series with a capacitor 240 to form a serial branch and all such capacitor-LED serial branches are connected in parallel to receive the drive power from the output of the secondary winding 520 of transformer 500 through an inductor 126. Current matching of the LED strings is accomplished by using identical capacitance value for all the balancing capacitors and the capacitance value is selected such that at the given frequency of the supply voltage, the voltage drop across the capacitor is significant enough in comparison with the LED operating voltage. Thus the effect of the difference in LED operating voltage will be largely suppressed. Given a difference of 5% of the operating voltage of a group of 40V LED strings, the resulted difference of the voltages across the balancing capacitors is 2V. If the working voltage of the capacitor is chosen to be equal to the LED operating voltage, i.e. 40V, the 2V difference is translated to 5% difference in the current flowing through the capacitor which is essentially also the current of the LED strings. Without the serial capacitor, the 5% different in the operating voltage would result in a difference of about 80% to 120% in the LED string current according to typical LED voltage current characteristics. It should be noted herein that the extra voltage dropped by the balancing capacitor would cause certain efficiency loss. But since the capacitor is a reactive component, the associated power is also reactive in nature and hence the loss is minimal. On the other hand, efficiency can still be improved by operating the conversion circuit at near full duty. Digital dimming can still be implemented herein by switching on and off the conversion circuit operation at low frequency with adjustable on duty to control the brightness. In addition to the half bridge circuit shown in FIG. 9, other types of symmetrical switching circuit such as push-pull or full bridge circuit are also applicable to drive such capacitor balanced bi-directional LED strings with the same spirit described above.

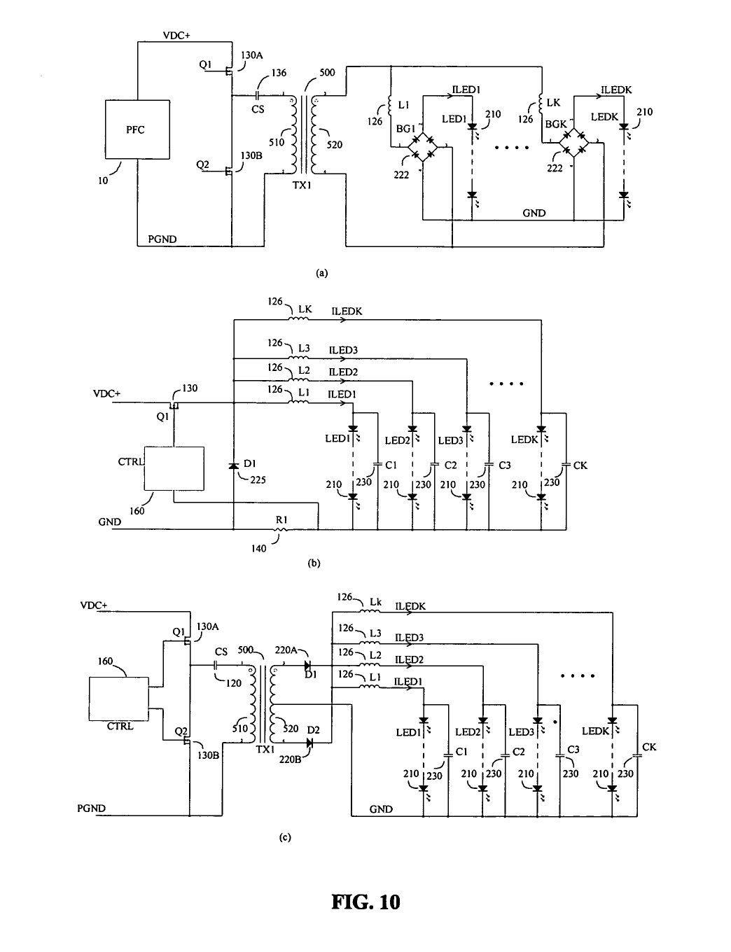

Apart from capacitor balancing, inductor can also be employed to balance the LED current. FIG. 10(a) shows an example that the balancing capacitor 240 in the circuit of FIG. 9 has been replaced by inductor 126 with identical inductance for all the branches to balance the current of the bi-directional LED structure. The principle of operation is the same as capacitor balancing concept and hence is not elaborated further. On the other hand, not like capacitors that work only at bi-directional signal conditions, inductor can be used with time varying signals containing DC component as well. FIGS. 10(b) and (c) showed examples of such approach. In FIGS. 10(b) and (c), each LED string 210 is connected in series with an inductor 126, and all such serial inductor-LED branches are connected in parallel to the DC output of the power conversion stage—a Buck converter in FIG. 10(b) and a half bridge circuit in FIG. 10(c). Again by using identical inductance value for all the inductors, the effect of the LED operating voltage difference on the LED current is effectively suppressed when set the inductor working voltage high enough compared to the operating voltage of the LED string. Finally, it should be noted again that in such approach sufficient off time has to be maintained for the switching operation of 130A and 130B in order to keep the inductor current at discontinuous mode to prevent balancing errors caused by DC bias accumulation of the inductor current.

It should be emphasized that while certain embodiments of the inventions have been described, these embodiments have been presented by way of example only, and are not intended to limit the scope of the inventions. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

I claim:

1. A LED drive system supplied by a DC voltage and comprised by at least one branch, each branch has a LED string connected in series with a regulating device, a current sensing element to sense the current of the LED string, and a control circuit, the LED current sensed by the sensing element is fed to the control circuit to switch the regulating device on and off periodically such that the integration of the sensed LED current signal over the on period of the regulating device operation, or a signal proportional to the integration of the sensed LED current signal over the on period of the regulating device operation, equals to a reference signal set for the control circuit, if the LED current is approximately constant during the on period of the regulating device operation, the integration of LED current signal over the on period of the regulating device operation can be alternatively represented by the multiplying product of the sensed LED current signal and the on time of the regulating device, or a signal proportional to the multiplying product of the sensed LED current signal and the on time of the regulating device.

2. The LED drive system of claim 1, in each branch an inductor is further inserted in series with the LED string, and an anti-parallel diode is connected across the LED string and the inductor with its connection polarity in opposite direction of the LED string, the LED current signal sensed by the sensing element is fed to the control circuit to switch the regulating device on and off periodically such that the integration of the sensed LED current signal over the on period of the regulating device operation, or a signal proportional to the integration of the sensed LED current signal over the on period of the regulating device operation, equals to a reference signal set for the control circuit, if the LED current is approximately constant during the on period of the regulating device operation, the integration of LED current signal over the on period of the regulating device operation can be alternatively represented by the multiplying product of the sensed LED current signal and the on time of the regulating device, or a signal proportional to the multiplying product of the sensed LED current signal and the on time of the regulating device.

3. The LED drive system of claim 2, the DC supply voltage to the system is converted by a half bridge, a push pull, or a full bridge conversion circuit from a DC input voltage, the said conversion circuit operates at a duty cycle range near full duty such that a zero voltage soft switching operation can be obtained.

4. The LED drive system of claim 2, the DC supply voltage to the system is set slightly higher than the highest forward operating voltage among the LED strings such that the inductance of the serial inductor can be set reasonably small to be realized by a low cost inductor, or by an embedded inductor constructed by conductor traces of a printed circuit board.

5. The LED drive system of claim 2, the DC supply voltage to the LED drive system can be turned on and off periodically at a frequency lower than the switching frequency of the regulating device, and the brightness of the system is controlled by the on duty of the DC supply.

6. A non-dissipative balancing method to balance the current of multiple LED strings without using active semiconductor devices under the circumstances that a DC component exists in the current of the LED strings, the realization circuit comprises at least two LED strings that are coupled with inductive components designated to the corresponding LED strings, the realization circuit is driven by a common supply power source, the supply power source is a time varying signal with a DC component and zero crossing intervals that enables the magnetic DC bias of the said inductive components to reset periodically.

7. A realization circuit of the non-dissipative balancing method of claim 6, comprising at least two LED strings and each LED string has a designated transformer, all the transformers have a primary winding and a secondary winding, the nominal turns ratio of all the transformers are preferably equal to set equal LED string current, or different to control the LED string current proportionally according to the turns ratio, the primary winding of each transformer is connected in series with the designated LED string to form a serial circuit branch, and all such serial branches are connected in parallel to the common supply power source, the secondary winding of all the transformers are connected in series to form a single circuit loop such that under normal operation, the induced currents in the secondary windings all flow in the same direction in the said single circuit loop.

8. A realization circuit of the non-dissipative balancing method of claim 6, comprising at least one transformer and two LED strings or load circuits, the said transformer has two windings with equal number of turns, each winding of the transformer is connected in series with a LED string or a load circuit to form a serial circuit branch, and such said serial branch are connected in parallel to the common supply power source, the two windings of the said transformer are connected in opposite polarity such that the currents in the two windings generate opposite magnetic flux in the transformer core, such current balancing circuit can be cascaded to drive more LED strings or load circuits.

9. A realization circuit of the non-dissipative balancing method of claim 6, comprising at least two LED strings and the same number of inductors, each LED string is connected in series with a designated inductor to form a serial circuit branch, all the inductors have equal nominal inductance value, all the said branches are connected in parallel to the common supply power source, the supply source is converted from a DC input by a power converter circuit that produces a time varying output with a DC component and zero crossing intervals that enables the magnetic DC bias of the inductor to reset periodically.

10. The LED current balancing circuit of claim 7 or 8, the supply power source of the balancing circuit is converted by a boost type power converter from a DC input voltage, or by a fly back type converter when electric isolation between the DC input and the LED circuit is needed, the said boost type and fly back type power converters can work in both continuous and discontinuous current mode.

11. The LED current balancing circuit of claim 7, 8 or 9, the supply power source of the balancing circuit is converted by a Buck type power converter from a DC input voltage, or by a forward type, a push-pull type, a half bridge type, or a full bridge type converter, the said converter circuits work only at discontinuous current mode wherein zero crossing intervals of the supply current to the said balancing transformers or inductors are obtained that enables the magnetic DC bias of the transformers or inductors to reset periodically.

12. A non-dissipative control method to control the current of a single or multiple LED strings without using active semiconductor devices, the realization circuit employs at least one bi-directional LED structure comprised by a LED string and a full bridge rectifier, the anode of the LED string is connected to the positive output terminal of the said rectifier, and the cathode of the LED string is connected to the negative output terminal of the rectifier, the two AC input terminals of the said rectifier serve as the input terminals of the bi-directional LED structure, such bi-directional LED structures are coupled with a reactive component network to control the LED current at non-dissipative manner.

13. A realization circuit of claim 12, comprising at least two bi-directional LED structures with each coupled to a designated transformer, the transformers have a primary winding and a secondary winding, one terminal of the primary winding of each transformer is connected to one of the input terminals of the designated bi-directional LED structure to form a serial circuit branch, and all such serial branches are connected in parallel to the common supply power source, the secondary winding of all the transformers are connected in series to form a single circuit loop such that under normal operation, the induced currents in the secondary windings all flow in the same direction in the said single circuit loop, the nominal turns ratio of all the transformers are preferably equal to obtain balanced current distribution among the said LED structures, or different to control the LED current proportionally according to the turns ratio, the supply power source of such realization circuit is converted from a DC input by a half bridge type, a push-pull type, or a full bridge type power converter, and outputted from the secondary winding terminals of the power transformer of the converter circuit with a smooth inductance in series, the smooth inductance can be realized by a separate inductor, or preferably by the leakage inductance of the secondary winding of the said power transformer.

14. A realization circuit of claim 12, comprising at least two bi-directional LED structures and one transformer, the transformer has two windings with equal number of turns, each winding of the transformer is connected in series with a LED string or a load circuit to form a serial circuit branch, and such serial branch are connected in parallel to the common supply power source, the two windings of the said transformer are connected in opposite polarity such that the currents in the two windings generate opposite magnetic flux in the transformer core, such balancing circuit can be cascaded to drive more LED strings or load circuits, the supply power source of such realization circuit is converted from a DC input by a half bridge type, a push-pull type, or a full bridge type power converter, and outputted from the secondary winding terminals of the power transformer of the converter circuit with a smooth inductance in series, the smooth inductance can be realized by a separate inductor, or preferably by the leakage inductance of the secondary winding of the said power transformer.

15. A realization circuit of claim 12, comprising at least one the said bi-directional LED structures, each bi-directional LED structure is connected in series with a capacitor to form a serial circuit branch, all the said capacitors have equal nominal capacitance value, all such serial branches are connected in parallel to a common supply power source and form a capacitive current control circuit, the supply power source of such capacitive current control circuit is converted from a DC input by a half bridge type, a push-pull type, or a full bridge type power converter, and outputted from the secondary winding terminals of the power transformer of the said converter circuit with a smooth inductance in series, the smooth inductance can be realized by a separate inductor, or preferably by the leakage inductance of the secondary winding of the said power transformer.

16. A realization circuit of claim 12, comprising at least one the said bi-directional LED structures, each bi-directional LED structure is connected in series with an inductor to form a serial circuit branch, all the said inductors have equal nominal inductance value, all such serial branches are connected in parallel to a common supply power source and form a inductive current control circuit, the supply power source of such inductive current control circuit is converted from a DC input by a half bridge type, a push-pull type, or a full bridge type power converter, and outputted from the secondary winding terminals of the power transformer of the said converter circuit.

17. The LED current balancing circuit of claim 10, 11, 13, 14, 15 and 16, the operation of the power converter can be turned on and off periodically at a frequency lower than the switching frequency of the converter circuit, and the brightness of the system is controlled by the on duty of the DC supply.

18. The LED drive system of claim 13, 14, 15 and 16, the said power conversion circuit operates at a duty cycle range near full duty such that a zero voltage soft switching operation can be obtained for the half bridge and push-pull circuit.
